(19) United States
(12) Patent Application Publication
(10) Pub. No.: US 2023/0302805 A1
(43) Pub. Date: Sep. 28, 2023

(54) SEALED BAG TO TEMPORARILY EXPAND AND RECEIVE FLUID THAT WOULD OTHERWISE DROOL DURING AN EXCEPTIONAL DROOLING EVENT

(71) Applicant: Hewlett-Packard Development Company, L.P., Spring, TX (US)

(72) Inventor: Steve A. O’HARA, Vancouver, WA (US)

(73) Assignee: Hewlett-Packard Development Company, L.P., Spring, TX (US)

(21) Appl. No.: 18/018,776

(22) PCT Filed: Aug. 31, 2020
(86) PCT No.: PCT/US2020/048720

§ 371 Date: Jan. 30, 2023

(51) Int. Cl. B41J 2/175

(52) U.S. Cl. CPC B41J 2/17513; B41J 2002/17516

(57) ABSTRACT

A fluid-ejection device includes a reservoir, a printhead, and a sealed bag. The reservoir is to hold fluid. The printhead is to eject the fluid from the device. The sealed bag is fluidically coupled to the reservoir and is to temporarily expand and receive the fluid that would otherwise drool from the printhead during an exceptional drooling event.

### BACKGROUND

Fluid-ejection devices include inkjet printing devices as well as other types of devices. Fluid-ejection devices can eject fluid via selective activation of firing elements, such as thermal resistors, which causes ejection of drops of fluid through corresponding nozzles. Backpressure at the nozzles prevents fluid from leaking, or drooling, from the nozzles when their corresponding firing elements are not activated.

### BRIEF DESCRIPTION OF THE DRAWINGS

FIGS. 1A and 1B are diagrams of an example fluid-ejection device having a sealed bag in compressed and expanded states, respectively.

FIGS. 2A and 2B are diagrams of an example off-axis or external fluid supply for a fluid-ejection device and that has a sealed bag in compressed and expanded states, respectively.

FIG. 3 is a diagram of an example fluid-ejection system including a fluid-ejection device and an off-axis or external fluid supply that each have a sealed bag.

FIG. 4 is a diagram of an example fluid-ejection device.

FIG. 5 is a diagram of an example fluid-ejection system.

### DETAILED DESCRIPTION

As noted in the background, fluid-ejection devices like inkjet-printing devices include firing elements that are selectively activated to eject drops of fluid through corresponding nozzles. The firing elements and the nozzles, among other components, can be part of a printhead die, which can also be referred to as simply a printhead. The printhead in turn may be part of a fluid-ejection assembly, such as an inkjet cartridge, which also includes one or multiple reservoirs of fluid like ink. The reservoirs may be the sole, self-contained source of fluid for the printhead in some types of fluid-ejection devices.

In other types of fluid-ejection devices, such as those known as continuous ink supply systems (CISSs), the reservoirs may be smaller intermediary reservoirs that are fluidically coupled to and replenished by corresponding larger off-axis or external fluid supplies. Fluid can in some cases continuously recirculate from the fluid supplies to the reservoirs, and even through the printhead. The fluid supplies may be part of or external to the fluid-ejection device. A fluid-ejection system can thus include one or multiple fluid supplies and a fluid-ejection device having a printhead and one or multiple corresponding reservoirs, where the fluid supplies may or may not be a part of the device.

Backpressure at the fluid-ejection device, and more specifically at the printhead (and more specifically still at the nozzles) prevents fluid from drooling from the nozzles when the firing elements are not activated. The backpressure may or may not be regulated. In a backpressure-unregulated fluid-ejection device, the reservoirs are sealed in that they are not vented to the external atmosphere.

In one type of backpressure-regulated fluid-ejection device, the reservoirs may be vented via fluidic connection to a pressure regulator that is vented to the external atmosphere. The pressure regulator may be vented through what is referred to as a tortuous path to minimize fluid leakage from the vent. In another type of backpressure-regulated fluid-ejection device, a vented pressure regulator that is not fluidically coupled to a reservoir may be disposed within the reservoir. Both types of pressure regulators may expand and contract with pressure changes between the external atmosphere and the reservoir to maintain a specified backpressure.

Pressure regulators add cost and complexity to a fluid-ejection device, however, and therefore many fluid-ejection devices are not backpressure-regulated. For such a fluid-ejection device having fluid-ejection assemblies with self-contained fluid sources (i.e., in which there are not off-axis or external fluid supplies), the lack of backpressure regulation can be an issue with two types of exceptional drooling events. (A drooling event is an event in which fluid drools from the fluid-ejection device, specifically from the printhead, and more specifically still from the nozzles of the die. The drooling event is exceptional in that the event infrequently or rarely occurs, and does not occur as part of the normal operation of the device when ejecting fluid.)

The first type of exceptional drooling event that can impact a fluid-ejection device with a self-contained fluid source is the rapid movement of the device to a high enough altitude, such as is the case during air transport, such that the relatively sudden decrease in atmospheric pressure sufficiently reduces backpressure to result in drooling. The second type of exceptional drooling event that can impact a fluid-ejection device with a self-contained fluid source is a sufficient increase in temperature of the fluid within the reservoir to cause any air bubbles trapped within the fluid to expand and cause fluid drooling. The fluid may sufficiently increase in temperature during continuous usage of the device for extended lengths of time, for instance.

For a backpressure-unregulated fluid-ejection device that has an off-axis or external fluid supply, the lack of backpressure regulation can be an issue with these two types of exceptional drooling events, as well as with a third type of exceptional drooling event. The backpressure within such a fluid-ejection device is effectively set by the static pressure head between the fluid reservoir and the fluid supply, such as the pressure head between the points of connection at the reservoir and the supply with an interconnecting fluidic tube. The third type of exceptional drooling event is a tipping or raising of the fluid supply relative to the fluid reservoir to a high enough degree that the corresponding backpressure reduction results in drooling.

Techniques described herein provide for a sealed bag to temporarily expand and receive fluid that would otherwise drool during an exceptional drooling event. The bag is fluidically coupled to the reservoir of a fluid-ejection device. The bag may be sealed in that it is not vented to the external atmosphere, and thus does not assist in regulating backpressure at a printhead of the device. The bag may normally be fully compressed to a minimum volume in which the bag does not hold any fluid, and may expand to receive fluid just during an exceptional drooling event. The bag thus expands and fills with fluid that would otherwise drool from the fluid-ejection device. Such a sealed bag is more cost effective than a pressure regulator like a pressure-regulating vented bag.

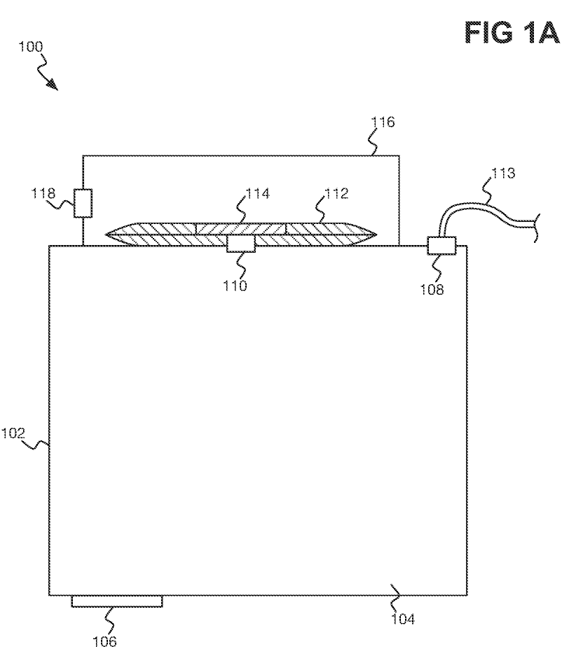

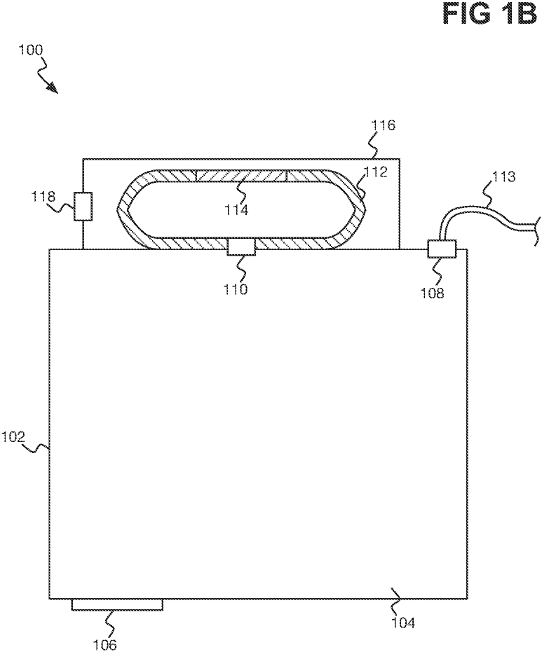

FIGS. 1A and 1B show an example fluid-ejection device 100. The fluid-ejection device 100 may be an inkjet-printing device, or another type of fluid-ejection device. The device 100 can include a fluid-ejection assembly 102, which may be in the form of a cartridge that is removably inserted into the device 100. Just one fluid-ejection assembly 102 is shown, but the device can include multiple such assemblies 102. The fluid-ejection assembly 102 includes a reservoir 104 to hold fluid like ink, and a printhead 106 to eject the fluid from the device 100. The printhead 106 can include multiple firing elements, such as thermal resistors, and corresponding nozzles.

The fluid-ejection device 100 can include a fluidic connection 108, such as a fluidic valve, by which the reservoir 104 receives fluid from an off-axis or external fluid supply via a fluidic tube 113. The reservoir 104 is replenished with fluid from this fluid supply, and the device 100 may be a CISS. The fluid may be continuously recirculated from the fluid supply to the reservoir 104, and even through the printhead 106. If there are multiple fluid-ejection assemblies 102 with multiple reservoirs 104, there can be corresponding fluidic connections 108 fluidically coupled to corresponding fluidic tubes 113. In another implementation, the reservoir 104 may be the sole, self-contained fluid source for the assembly 102, in which case the fluidic connection 108 is absent.

The fluid-ejection device 100 includes a sealed bag 112 fluidically coupled to the reservoir 104 via a fluidic connection 110, such as a valve. FIG. 1A depicts the bag 112 in a fully compressed state, whereas FIG. 1B depicts the bag in an expanded state. The bag 112 is sealed in that the bag is not vented to the external atmosphere. The bag 112 may include a sealing member 114 to seal the bag 112 shut against the fluidic connection 110 in the fully compressed state. When there is no occurrence of an exceptional drooling event, the backpressure of the fluid at the printhead 106 is sufficient to collapse the bag 112 to the fully compressed state, in which the bag 112 is fully compressed to a minimum state and does not hold any fluid.

When an exceptional drooling event occurs, the backpressure of the fluid at the printhead 106 sufficiently decreases to dislodge the sealing member 114 from the fluidic connection 110. The sealed bag 112 expands to an expanded state, such as that of FIG. 1B, and receives fluid that would otherwise drool from the printhead 106. That is, instead of the fluid leaking from the reservoir 104 through the printhead 106, the fluid fills the expanding bag 112. When the exceptional drooling event ceases to occur, the fluid reenters the reservoir 104 from the bag 112, and the bag 112 ultimately transitions back to the fully compressed state of FIG. 1A. In the fully compressed state, the bag 112 does not assist in regulating backpressure of the fluid at the printhead 106.

The sealed bag 112 thus temporarily expands to an expanded state in accordance with occurrence of an exceptional drooling event to prevent drooling. The bag 112 temporarily expands in accordance with reduced backpressure of the fluid at the printhead 106 that results from tipping of the fluid-ejection device 100, in the case in which the reservoir 104 is not a self-contained fluid source and is instead fluidically connected to an off-axis or external fluid supply. The bag 112 similarly temporarily expands in accordance with transportation of the device 100 to a reduced atmospheric pressure environment, as well as in accordance with increased temperature of the fluid within the reservoir 104.

The fluid-ejection device 100 can include a vented box 116 surrounding the sealed bag 112. The box 116 can be vented through a vent 118 that minimizes air transfer between the box 116 and the external environment while still permitting pressure equalization between the inside of the box 116 and the external atmosphere. The vent 118 may, for instance, be a valve that provides a tortuous path. Enclosure of the bag 112 within the vented box 116 reduces water vapor loss and air permeation through the bag 112 with respect to the external environment, while still permitting the bag 112 to expand and collapse as has been described. The effect that inclusion of the bag 112 within the fluid-ejection device 100 has on the fluid within the reservoir 104 is thus reduced.

In addition to or instead of being enclosed within the vented box 116, the sealed bag 112 can be metallized to reduce water vapor loss and air permeation. That is, the exterior of the bag 112 may have a metallized surface that resists vapor loss and air permeation. Regardless of whether the bag 112 is metallized or not, the bag 112 can be fabricated from a compliant material, such as a polymeric film, so that it can transition between compressed and expanded states. The sealing member 114, if present, may be fabricated from elastomeric material, and may be lubricated with glycol or another material to promote sealing with the fluidic connection 110 and maintain the bag 112 in a fully compressed state at minimum volume.

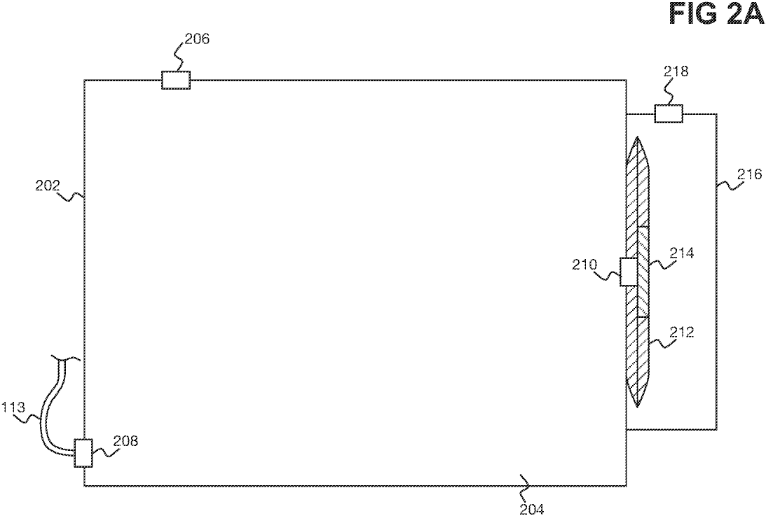

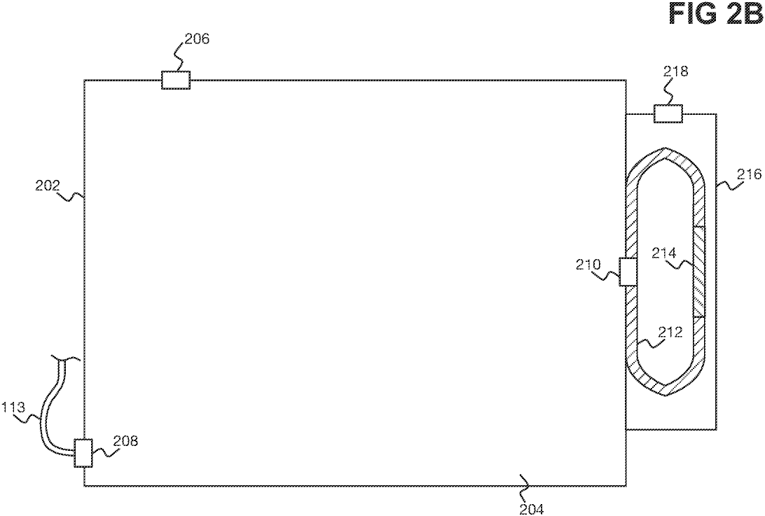

FIGS. 2A and 2B show an example fluid supply 202 for the fluid-ejection device 100 in the case in which the reservoir 104 of the device 100 is not a self-contained fluid source. The fluid supply 202 may be an off-axis fluid supply that is part of the fluid-ejection device 100, or may be an external fluid supply that is not part of the device 100. The fluid supply 202 includes a reservoir 204 to store fluid, and which may be larger in volume than the reservoir 104 of the fluid-ejection assembly 102.

The fluid supply 202 can include an atmospherically exposed vent 206 through which the reservoir 204 is vented to permit pressure equalization between the reservoir 204 and the external atmosphere. The vent 206 may be a valve that provides a tortuous path. The fluid supply 202 can include a fluidic connection 208, such as a fluidic valve, by which the reservoir 204 supplies fluid via the fluidic tube 113 to the reservoir 104 of the fluid-ejection assembly 102.

The fluid supply 202 includes a sealed bag 212 fluidically coupled to the reservoir 204 via a fluidic connection 210, such as a valve. FIG. 2A depicts the bag 212 in a fully compressed state, whereas FIG. 2B depicts the bag in an expanded state. The bag 212 is sealed in that the bag is not vented to the external atmosphere. The bag 212 may include a sealing member 214 to seal the bag 212 shut against the fluidic connection 210 in the fully compressed state. When there is no occurrence of an exceptional drooling event, the bag 212 may collapse to the fully compressed state, in which the bag 212 is fully compressed and does not hold any fluid.

When an exceptional drooling event occurs, the sealed bag 212 expands to an expanded state, such as that of FIG. 28, and receives fluid that would otherwise drool from the vent 206. That is, instead of the fluid leaking from the reservoir 204 through the vent 206, the fluid fills the expanding bag 212. When the exceptional drooling event ceases to occur, the fluid may reenter the reservoir 204 from the bag 212, and the bag 212 may ultimately transition back to the fully compressed state of FIG. 2A. The bag 212 may thus temporarily expand to an expanded state in accordance with occurrence of an exceptional drooling event to prevent drooling.

The fluid supply 202 can include a vented box 216 surrounding the sealed bag 212. The box 216 can be vented through a vent 218 that minimizes air transfer between the box 216 and the external environment while still permitting pressure equalization between the inside of the box 216 and the external atmosphere. Enclosure of the bag 212 within the vented box 216 reduces water vapor loss and air permeation through the bag 212, while still permitting the bag 212 to expand and collapse.

In addition to or instead of being enclosed within the vented box 216, the sealed bag 212 can be metallized to reduce water vapor loss and air permeation. Regardless of whether the bag 212 is metallized or not, the bag 212 can be fabricated from a compliant material so that it can transition between compressed and expanded states. The sealing member 214, if present, may be fabricated from elastomeric material, and may be lubricated to promote sealing with the fluidic connection 210 and maintain the bag 212 in a fully compressed state at minimum volume.

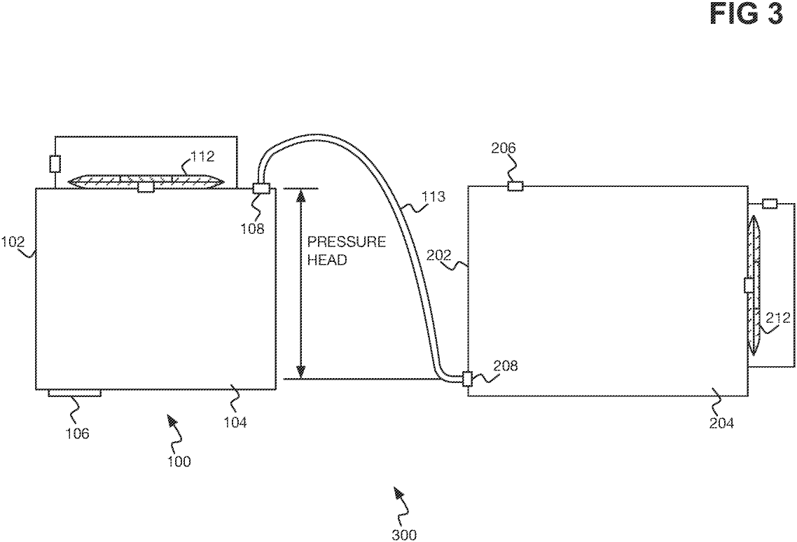

FIG. 3 shows an example fluid-ejection system 300 including the fluid-ejection device 100 and the fluid supply 202. The fluid supply 202 may be part of the fluid-ejection device 100 or may be external to the device 100. The fluidic tube 113 fluidically interconnects the fluid-ejection device 100 and the fluid supply 202. Specifically, the fluidic tube 113 fluidically interconnects the fluid reservoir 104 of the fluid-ejection device 100 at the fluidic connection 108 and the fluid reservoir 204 of the fluid supply 202 at the fluid connection 208. The pressure head between the fluidic connections 108 and 208 maintains the backpressure at the printhead 106 of the fluid-ejection device 100.

When an exceptional drooling event occurs, either or both of the sealed bags 112 and 212 can expand from their fully collapsed states depicted in FIG. 3 to their expanded states, such as their respective expanded states of FIGS. 1B and 2B. If the bag 112 temporarily expands, it fills with fluid from the reservoir 104 that would otherwise drool through the printhead 106. If the bag 212 temporarily expands, it fills with fluid from the reservoir 204 that would otherwise drool through the vent 206. For instance, both bags 112 and 212 may temporarily expand in accordance with transportation of the system 300 to a reduced atmosphere pressure environment.

The bags 112 and 212 may correspondingly temporarily expand in accordance with increased temperature of the fluid within their respective reservoirs 104 and 204. Just the bag 112 may temporarily expand if the fluid supply 202 is raised relative to the fluid-ejection assembly 102 of the fluid-ejection device 100, such as in the case in which the fluid supply 202 is part of the device 100 and the device 100 is tipped counter-clockwise. By comparison, just the bag 212 may temporarily expand if the fluid-ejection assembly 102 is raised relative to the fluid supply 202, such as in the case in which the fluid supply 202 is part of the device 100 and the device 100 is tipped clockwise.

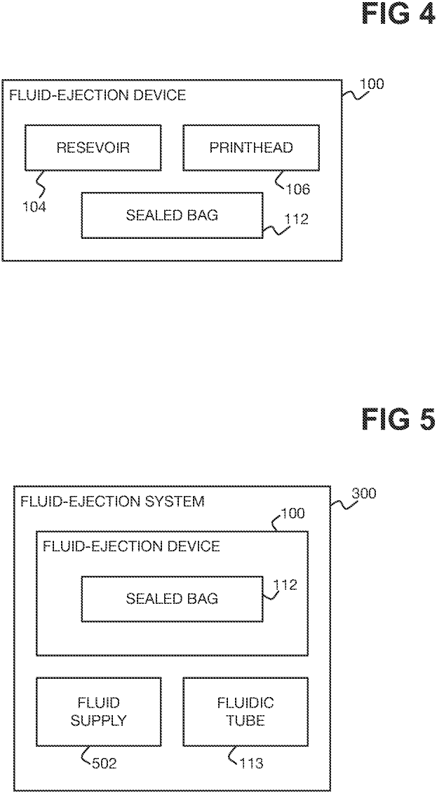

FIG. 4 shows an example fluid-ejection device 100. The fluid-ejection device 100 includes a reservoir 104 to hold fluid, and a printhead 106 to eject the fluid from the device 100. The fluid-ejection device 100 includes a sealed bag 112 fluidically coupled to the reservoir 104 to temporarily expand and receive the fluid that would otherwise drool from the printhead 106 during an exceptional drooling event.

FIG. 5 shows an example fluid-ejection system 300. The system 300 includes a fluid supply 502. The fluid supply 502 may be a fluid supply including a sealed bag, such as the fluid supply 202 that has been described, or a fluid supply that does not include a sealed bag. The system 300 includes the fluid-ejection device 100 of which the fluid supply 502 may or may not be a part.

The fluid-ejection device 100 is to eject fluid. The device 100 has a sealed bag 112 to temporarily expand and receive the fluid that would otherwise drool from the device 100 during an exceptional drooling event. The system 300 includes a fluidic tube 113 fluidically interconnecting the fluid supply 502 and the fluid-ejection device 100, through which the device 100 is to receive the fluid.

Techniques have been described for providing a sealed bag that temporarily expands and receives fluid that would otherwise drool during an exceptional drooling event. The sealed bag differs from a pressure-regulating vented bag in that the sealed bag does not assist in maintaining backpressure when an exceptional drooling event is not occurring. Further, unlike a pressure-regulating vented bag, which contracts in accordance with reduced backpressure, the described sealed bag expands in accordance with reduced backpressure.

I claim:

1. A fluid-ejection device comprising:
a reservoir to hold fluid;
a printhead to eject the fluid from the device; and
a sealed bag fluidically coupled to the reservoir to temporarily expand and receive the fluid that would otherwise drool from the printhead during an exceptional drooling event.

2. The fluid-ejection device of claim 1, wherein the bag is sealed in that the bag is not vented to an external atmosphere.

3. The fluid-ejection device of claim 1, wherein the bag is normally fully compressed to a minimum volume in which the bag does not hold any fluid.

4. The fluid-ejection device of claim 1, wherein the bag does not assist in regulating backpressure of the fluid at the printhead.

5. The fluid-ejection device of claim 1, wherein the bag temporarily expands in accordance with reduced backpressure of the fluid at the printhead resulting from tipping of the fluid-ejection device, to prevent occurrence of the exceptional drooling event.

6. The fluid-ejection device of claim 1, wherein the bag temporarily expands in accordance with transportation of the fluid-ejection device to a reduced atmospheric pressure environment, to prevent occurrence of the exceptional drooling event.

7. The fluid-ejection device of claim 1, wherein the bag temporarily expands in accordance with increased temperature of the fluid within the reservoir, to prevent occurrence of the exceptional drooling event.

8. The fluid-ejection device of claim 1, wherein the bag is metallized to reduce water vapor loss and air permeation through the bag.

9. The fluid-ejection device of claim 1, further comprising a vented box surrounding the bag to reduce water vapor loss and air permeation through the bag.

10. A fluid-ejection system comprising:
a fluid supply;
a fluid-ejection device to eject fluid, the fluid-ejection device having a sealed bag to temporarily expand and receive the fluid that would otherwise drool from the device during an exceptional drooling event; and
a fluidic tube fluidically interconnecting the fluid supply and the fluid-ejection device, through which the device is to receive the fluid.

11. The fluid-ejection system of claim 10, wherein the fluid supply comprises:
a reservoir to store the fluid;
an atmospherically exposed vent; and
a sealed bag fluidically coupled to the reservoir to temporarily expand and receive the fluid that would otherwise drool from the vent during the exceptional drooling event.

12. The fluid-ejection system of claim 10, wherein the bag is normally fully compressed to a minimum volume in which the bag does not hold any fluid.

13. The fluid-ejection system of claim 10, wherein the fluid supply and the fluid-ejection device each have a fluidic connection to the fluidic tube,
wherein backpressure of the fluid at the fluid-ejection device is maintained by a pressure head between the fluidic connection of the fluid supply and the fluidic connection of the device,
and wherein the bag does not assist in regulating the backpressure.

14. The fluid-ejection system of claim 10, wherein the bag is metallized to reduce water vapor loss and air permeation through the bag.

15. The fluid-ejection system of claim 10, further comprising a vented box surrounding the bag to reduce water vapor loss and air permeation through the bag.
